(19) United States
(12) Patent Application Publication
(10) Pub. No.: US 2014/0280639 A1
(43) Pub. Date: Sep. 18, 2014

(54) Methods, Systems, and Devices for Analyzing Social Media Content

(71) Applicants: UNIVERSITY OF SOUTHAMPTON, Southampton (GB); EDELMAN , INC., Chicago, IL (US)

(72) Inventors: Jonny Bentwood, London (GB); Jonathan Hargreaves, London (GB); Ramine Tinati, Southampton (GB); Wendy Hall, Southampton (GB); Leslie Carr, Southampton (GB)

(73) Assignees: UNIVERSITY OF SOUTHAMPTON, Southampton (GB); EDELMAN , INC., Chicago, IL (US)

(21) Appl. No.: 14/076,402

(22) Filed: Nov. 11, 2013

Related U.S. Application Data
(60) Provisional application No. 61/787,432, filed on Mar. 15, 2013.

(51) Int. Cl. H04L 12/58

(52) U.S. Cl. CPC H04L 51/32
USPC 709/206

(57) ABSTRACT

A system for analyzing social media content and for determining the influence types of different social media members is disclosed. The system categorizes users according to their influence on the social media conversation and displays information related to this categorization in schematic form. The popularity of a particular topic can be analyzed to determine when the topic resonates and becomes more popular within the social network. In some embodiments, the categorization of the users and schematic display of information can be conducted in real-time.

### RELATED APPLICATION

This application claims priority to provisional Patent Application No. 61/787,432, filed Mar. 15, 2013, the contents of which are herein incorporated by reference in their entirety.

### TECHNICAL FIELD OF THE INVENTION

The present application relates generally to social networks. Particularly, the present application relates to analyzing participants in a social media network and their influence or contribution to a particular string of social media content.

### BACKGROUND OF THE INVENTION

Social networks, such as Facebook®, Twitter®, or the like, are commonplace in today's society. Members of social networks communicate with other members by “posting” publicly viewable comments or by directly messaging a selected member. Posted messages can typically be commented upon, “liked,” or re-posted by other members. As one example, Twitter® allows its members to send “tweets” that then be shared by the recipients by “re-tweeting” the original “tweet”. A social media message can therefore resonate from one member of the network to other members that may not be directly connected to the member who created the original message.

Different members of social network sites can have different levels of influence on a particular message or topic. For example, a celebrity can cause a message or topic to resonate rapidly based on their perceived status, whereas an ordinary member with fewer “friends” or “followers” may be less able to increase the popularity of a particular topic. Different social media members also behave differently and process messages differently, such as, for example, “re-tweeting” all message or “re-tweeting” only certain messages, and as a result, such members influence topics or messages in different ways.

### SUMMARY OF THE INVENTION

The present application discloses methods, systems, and devices for analyzing social-media content and determining the influence types of different social media members have on others. The application discloses an embodiment where users are categorized in real-time according to their influence type as, for example, an idea starter, amplifier, curator, commentator, viewer, or any combination of the above. The results of this categorization can be displayed in schematic form, also in real-time, showing the travel path of the messages and the influence of each member on others in the network. In an embodiment, different algorithms are used to determine the influence of selected members of the social media network.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a schematic diagram of a system according to an embodiment of the present application;

FIG. 2 is a schematic diagram of a user device according to an embodiment of the present application;

FIG. 3 is a flowchart illustrating a process according to an embodiment of the present application;

FIG. 4 is a flowchart illustrating a process for filtering data according to an embodiment of the present application;

FIG. 5 is a flowchart illustrating a process for visualizing data according to an embodiment of the present application;

FIG. 6 is a schematic diagram of a network map according to an embodiment of the present application;

FIG. 7 is a graphical visualization of topic or message frequency according to an embodiment of the present application; and

FIGS. 8a-8f is an illustration of a dashboard displaying processed data according to an embodiment of the present application.

It should be understood that the comments included in the notes as well as the materials, dimensions and tolerances discussed therein are simply proposals such that one skilled in the art would be able to modify the proposals within the scope of the present application.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated.

The present application discloses a system for analyzing social-media content and for determining the influence types of different social media members have on other members. In an embodiment, the system categorizes users according to their influence type, for example, as an idea starter, amplifier, curator, commentator, viewer, or any combination of the above. The results of this categorization can be displayed in schematic form on a network map that illustrates the message travel path and influence types of each user. The popularity of a particular topic can be analyzed to determine when the topic resonates and becomes more popular within the social network. In some embodiments, the categorization of the users and schematic display of information can be conducted in real-time.

As shown, FIG. 1 depicts a system 100 for communicating between user devices 105 within a network 110. For example, the network 110 can be a social network powered by a server 115 communicably coupled to the user devices 105 through the network 110 by communication links 120.

The user device 105 can be a device of any type that allows for the transmission and/or reception of data. By way of example, the user device 105 can include a smart phone (e.g. iPhone®), tablet, personal computer, voice and video telephone set, streaming audio and video media player, integrated intelligent digital television receiver, DVS receiver, work station, radio, personal digital assistant (PDA), mobile satellite receiver, GPS receiver, software system, social network or any combination of the above.

The network 110 may be a single network or a plurality of networks of the same or different type. For example, the network 110 may include a local telephone network (such as a Bell Atlantic telephone network) in connection with a long distance network (such as an AT&T long distance telephone network). Further, the network 110 may be a data network, an Intranet, the Internet or a telecommunications network in connection with a data network. Any combination of telecommunications and data networks may be used without departing from the spirit and scope of the present application. For purposes of discussion, it will be assumed that the network 110 is the Internet.

The server 115 can also be a device of any type that allows for the transmission and/or reception of data, and that is capable of storing information to be transmitted to the user device 105. For example, the server 115 can include any device listed above with respect to the user device 105, or can include any non-transitory computer-readable recording medium, such as a hard drive, DVD, CD, flash drive, volatile or non-volatile memory, RAM, or any other type of data storage.

The communication links 120 may be any type of connection that allows for the transmission of information. Some examples include conventional telephone lines, fiber optic lines, direct serial connections, cellular telephone connections, satellite communication links, local area networks (LANs), intranets, and the like.

FIG. 2 illustrates a schematic diagram of a user device 105 according to an embodiment of the present application. As shown, the user device 105 includes an interface 205, a processor 210, a transceiver 215, a display 220, and a memory 225, each communicably coupled to one another.

The interface 205 allows the user to input information or commands into the user device 105 and to transmit the information or command to the server 115 via the network 110. By way of example, the interface 205 can include a keyboard, mouse, touch screen, audio recorder, audio transmitter, member pad, or any other device that allows for the entry of information from a user.

The processor 210 facilitates communication between the various components of the user device 105. The processor 210 can be any type of processor or processors that alone or in combination facilitate communication within the user device 105 and, together with the transceiver 215, are adapted to transmit information from the user device 105 to external devices. For example, the processor 210 can be a desktop or mobile processor, a microprocessor, a single-core or a multi-core processor.

The transceiver 215 can be any device capable of transmitting data from the user device 100 or capable of receiving data within the user device 105 from an external data source. By way of example, the transceiver 215 can be any type of radio transmission antenna, cellular antenna, hardwired transceiver, or any other type of wired or wireless transceiver capable of communicating with an external device.

In an embodiment, the display 220 can display various information for the user to view and interpret, including social network websites, search engines, text or graphics, or information entered into the interface 205. By way of example, the display 220 can include a liquid crystal display (LCD), organic light emitting diode (OLED) display, plasma screen, cathode ray tube display, or any other kind of black and white or color display that will allow the user to view and interpret information on the user device 105.

In an embodiment, the memory 225 can store any information from the server 115 via the network 110 or any information not received through the server 115 or network 110. The memory 225 can also store an operating system for the user device 105 or any other software or data that may be necessary for the user device 100 to function. Similar to the server 115 discussed above, the memory 225 can include any non-transitory computer-readable recording medium, such as a hard drive, DVD, CD, flash drive, volatile or non-volatile memory, RAM, or any other type of data storage.

FIGS. 3-5 illustrate processes for analyzing and visualizing data according to an embodiment of the present application. As shown, FIG. 3 begins and proceeds to step 305, where data is received from a social network.

Data can be received by either importing the data from a social network, or by initiating live streaming so that data is obtained directly from the social network's application programming interface (API). For example, the process 300 can import either custom or general-formatted data from the social network, with such data being formatted by either a comma separated value (CSV) format and the standards therein, or an extensible markup language (XML) structure. Any received data can exist in a format that is custom-designed for the method 300, or that is generic to the process 300.

Once data is received from the social network, the process proceeds to Step 310, where the received data is pre-processed. The pre-processing step 310 converts the received data into a usable format for the system 300, if such a conversion is necessary. In an embodiment, the pre-processing step 310 transforms the data into a structured software model suitable for processing by the visualization engine or filtered using the filter engine, both of which are discussed below in greater detail. In an embodiment, the pre-processing step transforms the raw, unstructured data into an object-led data structure, thereby extracting all the information from the imported or live stream data, including, but not limited to, social network messages and associated timestamps, unique identifiers for social network members, and content of the message. With this information, the method 300 can compute a model of interaction between the members of the social network, and visualize the communication patterns between the members based on the direct messages, public messages, shared content, “liked” content, views, or any other interaction between the member and social network.

In an embodiment, the step of pre-processing S310 can be performed by an algorithm that involves two components: (1) Matching the text of the message, and (2) Constructing a “chain” of unoriginal shared messages.

Matching the text of the message first involves matching the string patterns between each of the messages within the dataset. To accomplish this, step S310 can perform an approximate string matching technique as well as incorporating the Levenshtein Distance calculation to help determine if the messages are similar and include the same content. Step 310 can therefore take into consideration small variations within the message's text, which may include differences such as extra “white spaces”, grammatical or typographical errors, spurious ASCII characters, etc. Provided a specific degree of accuracy, which can be set by the user, messages are considered similar if the messages fall within the boundaries set.

Constructing a “chain” of unoriginal shared messages can include a temporal analysis of the messages within the chain to firstly ensure that the messages are actually part of the same chain, and secondly to restructure the unoriginal shared messages chain to represent the dissemination pattern in chronological order. Several parameters can be considered during the validation and reordering process, such as time between the unoriginal shared messages, and volume of unoriginal shared messages. Based upon the combination of these parameters step S310 can statistically validate whether the messages are identified as part of the same unoriginal message chain, and if validation is confirmed, then the chain is reordered to represent the dissemination of information overtime.

In an embodiment, the data can be filtered in step 315 after the data is pre-processed in step 310. As discussed below in more detail with respect to FIG. 4, the step of filtering data 315 characterizes members of the social network based on their activities and behavior therein, and further constructs visually-intuitive communication network data sets that can be visualized with the visualization engine in step 320. For example, the visualization engine can produce a schematic or graphical representation of the social network data to illustrate to the user how a social network topic or message has resonated throughout the social network. In some embodiments, this schematic and graphical representation can be presented in real-time to illustrate to the user the current status of the social network and/or selected social network messages or members.

In an embodiment, the user can also export the data in step 325. For example, for better ease of use or data manipulation, the user can export the data to a spreadsheet or other format to be used in other software applications.

FIG. 4 illustrates a process of filtering data 315 according to an embodiment of the present application. As shown, the process begins and proceeds to step 405, where fields from a social network message are extracted. For example, in step 405, the filtering process 315 can extract fields such as the name of the message author, the content of the message, timestamp information of the message, any categorization of the message (e.g., “hash tagging”), or any other field of the social network message that can be used to link to another message that is identical or similar to the original social network message.

The extracted fields are then matched against other fields in other social network messages to verify similarities between the social network messages. For example, the filtering method 315 can compare the content of a Twitter® “tweet” to content of another Twitter® “tweet” that may be similar, and determine that the topic of both “tweets” is the same. Accordingly, in this step, the filtering method 315 can determine in real-time that the message has indeed resonated and can analyze the role of each member in that resonation.

In step 415, information flow pathways can be determined for matched messages across the social network. For example, after matching patterns and verifying similarities between social network messages in 410, the step of filtering data 315 can determine which members shared the original social network message and can record an information flow pathway between the member that originally published the message and the member that shared the originally-published message. The method of filtering data at 315 can then determine the communication network by aggregating each of the information flow pathways, as shown in step 420.

Many social networks do not provide a “backlink” to show the path of a shared message, so time can be used as a factor to determine the order to which members of the social network come in the chain of shared messages, and the different “gaps” in time that occur when a message is shared. For example, the process 300 can extract timestamps of the message in step 310, analyze those timestamps for temporal data in step 315, and visualize the timestamp data in step 320. This process can help the user determine, for example, whether the message was shared ten times in two minutes, or ten times in two days. Analyzing timestamp information can also help determine whether a first member shared the message quickly while a second member shared the message after a substantial gap in time. All of these factors can be analyzed within the spirit and scope of the present application.

The step of filtering data can then classify members of the social network, as shown in step 425. The filtering model classifies social network members based on their unique network characteristics and behavior within the social network. In some embodiments, the social network members can be classified in real-time and displayed real-time in a dashboard-type display. The following are social network categories that can be used to classify social network members.

1. Idea Starter

2. Amplifier

3. Curator

4. Commentator

5. Viewer

It is to be understood that the category names used herein are for illustrative and exemplary purposes only, and such categories can be called or named anything without departing from the scope and spirit of the present application.

A member of the social network can be classified in any one or more of the above categories. Many times, the member will be categorized as having qualities associated with more than one of the above categories, e.g., a part commentator and part idea starter. The member can thereafter be visualized on a network map (see, e.g., FIG. 6) in a color that corresponds to the category or categories represented by the member. A description of each of these categories is provided below with the intent to provide a general understanding of the principles associated with these categories, while not limiting their definition.

1. Idea Starter

An Idea Starter is an individual who typically starts a social network conversation. The term “social network conversation” means messages published or transmitted across a social network that relate to substantially the same topic. An Idea Starter can be highly engaged with the media, both online and offline, and can sometimes utilize multiple sources of social media, but have an intricate network of trusted relationships, especially online. Sometimes, the idea starter can have a low number of high-quality “connections” within their social network(s).

The name “Idea Starter” may be a misnomer because, in some circumstances, the Idea Starter does not actually start the idea, but instead starts the conversation. However, due to the high-quality connections of the Idea Starter, the conversation commonly begins here due to the fertile environment provided by the online behavior and characteristics of the Idea Starter.

One process of determining whether a social network member is an Idea Starter is to apply the following algorithm:

$$\frac{\sum {U}^{rt}}{{RT}^{min}} > 1$$

Where U^{rt} is the number of unoriginal shared messages (e.g., “retweets” for Twitter®) and RT^{min} is the minimum number of unoriginal shared messages, as designated by a user or as predetermined by the method. Other algorithms or methods could also be used to determine a particular member is an Idea Starter without departing from the spirit and scope of the present application.

2. Amplifier

A member may be classified as an Amplifier if the member typically collates multiple thoughts and shares ideas and opinions, for example. Amplifiers typically thrive off sharing opinions of others and enjoy being the first to do so. The Amplifier can have a large network of connections and are usually trusted within their community.

Historically, although not necessarily, Amplifiers can be part of a small trusted network of Idea Starters, sharing the messages of the Idea Starter to a larger, more visible audience. Due to this process, Idea Starters can sometimes become Amplifiers over time due to increased exposure to the social network.

An Amplifier can be a member who initially shares a social network message—one which is part of a message chain of length n. For example, the pre-processing engine can calculate the chain length n and then apply a model to calculate if a specific member is an Amplifier. Furthermore, as an additional metric to further distinguish between the members categorized as Amplifiers, in an embodiment, the model calculates the number of times the member is the n+1 user in the retweet chain.

One process of determining whether a social network member is an Amplifier is to apply the following algorithm:

$$\frac{\sum {U}^{t}}{\sum {RT}^{u} \times \sum {rt}^{orig}} > 1$$

Where U^{t} is the total number of original or unoriginal shared messages of the member (e.g., “tweets” for Twitter®), RT^{u} is the number of unoriginal shared messages by the member (e.g., the number of the user's “retweets”), and rt^{orig} is the number of the member's shared messages that were the first message in a chain of shared social network messages (e.g., the number of original messages in a “retweet chain”). Other algorithms or methods could also be used to determine a particular member is an Amplifier without departing from the spirit and scope of the present application.

3. Curator

A social network member can be considered a Curator if, for example, the member is typically part of multiple unoriginal shared message chains, where the Curator's position in the chain is n. For example, a Curator can receive two unoriginal shared messages (e.g., retweets on Twitter®) and share those messages with the network of the member.

Historically, although not necessarily, Curators are a point of aggregation in their network and more transparent than Idea Starters or Amplifiers. Curators impact the way the conversation is shaped and spread by following the conversation path. For example, Curators take the ideas of the Idea Starters and the Amplifiers and either validate, question, challenge, or dismiss those ideas. In some cases, the Curators connect the Idea Starters and Amplifiers, aggregating the ideas together to help clarify and steer the topic of conversation. Curators can be connected to a large audience, and often pick up information outside their primary community of interest—tailoring the information to suit their network's circle of interest.

In an embodiment, the pre-processing engine can first be used to calculate the number of unoriginal shared message chains, and then members are characterized as Curators by implementing the following algorithm:

$$\frac{\sum {RT}^{u}}{\sum {U}^{uniqRT}} > 2$$

Where RT^{u} is a number of unoriginal shared messages by the social network member (e.g., the number of “retweets” by the member), and U^{uniqRT} is the number of unique social network members that the Curator has shared unoriginal messages from.

4. Commentator

Commentators are considered those users who typically actively share social network messages and that do not fall under any of the criteria set forth above (Idea Starters, Amplifiers, or Curators). Other methods can be used to designate a social network member as a Commentator without departing from the spirit and scope of the present application.

Commentators are typically individuals who detail and refine ideas. In an embodiment, Commentators add to or adapt the flow of conversation, adding their own opinions and insights, but without becoming too immersed in the conversation. Unlike the above categories, Commentators typically do not seek recognition of their leadership, and have little desire to increase their status. Rather, more commonly, Commentators are simply taking part in something to which they strongly feel about. They want to share the conversation but not for self-benefit.

5. Viewer

Viewers are individuals who do not fall under any of the criteria set forth above (Idea Starters, Amplifiers, Curators, or Commentators). Viewers typically do not actively share unoriginal messages and instead simply view the unoriginal messages without sharing.

Viewers are typically individuals who take a passive interest in a social network conversation. Viewers are typically only connected to the conversation because of their footprint left by viewing rather than contributing to the conversation. However, even though the Viewer is not active, they are still reflected in the topic of interest because the Viewer typically consumes large amounts of information and shares it with their offline network.

The method 300 can determine a particular member is a Viewer by calculating a predetermined number of views divided by a predetermined number of shares (of a particular social network message), although other parameters can be used to determine a member is a Viewer without departing from the spirit and scope of the present application.

FIG. 5 discloses a process for visualizing the data processed by the process 300. Each of the illustrated methods of visualizing data are optional, and not necessarily mutually exclusive. Further, each of the illustrated steps can be implemented in any order, or generally omitted. As shown, the process can visualize data by mapping a network 505 with data received and processed through the disclosed methods and systems. An example of such a map is shown in FIG. 6. Further, the process can visualize data by graphically displaying the frequency of messages relating to the topic 510, as shown in FIG. 7. A dashboard of the processed data can also be displayed 515, as shown in FIGS. 8a-8f.

The methods, devices, and systems disclosed in the present application can be used in a variety of ways. For example, prior to a topic gaining large resonation (the “pre-campaign” period), the influencers can be identified as discussed above. While a topic is resonating (the “campaign” period), users of the process 300 can implement crisis management in a reactive role by using the data provided in real-time, monitor issues in a proactive role, and/or manage the conversation by adapting, hijacking, or connecting with the messages and members of the social network. After a topic has resonated (the “post-campaign”), a user can measure and evaluate the data processed by the system.

For pre-campaign activities, key influencers can be identified in real-time (as the source of social network messages) or via historic data (as the Idea Starter, Amplifier or Curator, or combinations of the above). These identifications are shown in FIG. 6. For example, the process 300 can export data containing the user names of particular social media members broken down into their separate behavior type as separate CSV documents, or in any other format of data or document.

During the campaign, the process 300 can proactively identify in real-time where conversations are resonating so the user can engage in the topic and determine where the most receptive group of members are located within the social network. For example, the reputation of a brand is critical to its success and social networks can quickly tarnish that brand if left untouched. The process 300 helps monitor online conversations to help protect the brand by understanding when conversations are resonating. In an embodiment, the process 300 focuses on the amount of volume around a specific social media message and highlights the member in real time whenever a message has reached a pre-defined level of resonance (e.g., the number of retweets or shared messages). The process 300 can therefore be used to provide alerts (as shown in FIG. 7) to predict when an issue becomes widely discussed so that proactive engagement can occur.

Post-campaign, a user can implement the method and conduct effective measurement and evaluation of campaigns and conversations. In an embodiment, the process 300 can export core data summaries to allow simple and quick reporting or data manipulation (as shown in FIG. 8). As shown in FIG. 8, the process 300 determines which social network messages are merely “noise,” for example, a tweet that is broadcasted by a member that has no resulting retweet by other members. A report can then be created simply by showing, for example, the total volume of social network messages split into those members that share the messages.

Several of the above processes are described as being implemented, or capable of being implemented, in real-time. However, the present invention is not so limited and embodiments of the present application may be performed either in real-time or in a proactive/reactive manner.

As used herein, the term “coupled” means any physical, electrical, magnetic, or other connection, either direct or indirect, between two parties. The term “coupled” is not limited to a fixed direct coupling between two parties or by any other limitation.

Some embodiments of the present application are discussed herein as being embodied within the method 300. However, the method 300 itself, or any other method or individual step discussed herein, can be embodied on one or more of the user device 105, server 115, or network 110, without departing from the spirit and scope of the present invention. Further, the methods discussed herein, or any individual steps thereof, can be embodied on non-transitory a computer-readable medium of the user device 105 (described above as the memory 225), server 115, or any other non-transitory a computer-readable medium on the network 110 and communicable with the user device 105 and/or the server 115. In each case, the non-transitory computer-readable recording medium can be any device capable of storing data, including but not limited to a hard drive, DVD, CD, flash drive, volatile or non-volatile memory, RAM, or any other type of data storage.

The process 300 above is described as being implemented within a social network, for example, Twitter®, Facebook®, or the like. However, the process 300 can be implemented in any computer or electrical network, or through individuals not necessarily connected by computer means.

As discussed herein, in certain embodiments, the method 300 operates, analyzes and/or extracts data from a social media message. However, the method 300 can operate on any type of message or any type of data without departing from the spirit and scope of the present invention. The term “social media message,” or any similar term used herein, is not intended to be limited to direct messages between users of a social network. Indeed, the term “social media message” broadly covers any interaction over a social network or other type of network, including, but not limited to, a tweet (as with, e.g., Twitter®), a comment (as with, e.g., Facebook®), a share (as with, e.g., Facebook®), a like (as with, e.g., Facebook®), a direct message, a pin (as with, e.g., Pinterest®), or any other form of interaction over a social network or other type of network.

The methods described above are illustrative only and provide one possible method of implementing the invention. The methods are not meant to be limited to the order in which the steps are written, nor are any of the steps intended to be considered mandatory to carry out the inventive method. Any of the steps can be considered optional and the steps of any method disclosed herein can be performed in any order without departing from the spirit and scope of the present invention.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the claims of the nonprovisional application when viewed in their proper perspective based on the prior art.

What is claimed is:

1. A method for analyzing social media content distributed on a social network comprising:
receiving message data from the social network;
determining a message content from the message data;
categorizing a plurality of messages as having a same message content;
determining social network members who have transmitted the same message content; and
classifying the social network members according to influence on a transmission of the same message content, the influence being determined by analyzing a number of times the social network members transmitted an unoriginal message previously received by the respective social network member.

2. The method of claim 1, wherein the step of classifying the social network members includes classifying a social network member as an idea starter if
$$\frac{\sum {U}^{rt}}{{RT}^{min}} > 1$$
where U^{rt} is a number of unoriginal shared messages and RT^{min} is a minimum number of unoriginal shared messages.

3. The method of claim 2, wherein the minimum number of unoriginal shared messages is one of determined by a user and predetermined prior to the step of classifying the social network members.

4. The method of claim 1, wherein the step of classifying the social network members includes classifying a social network member as an amplifier if
$$\frac{\sum {U}^{t}}{\sum {RT}^{u} \times \sum {rt}^{orig}} > 1$$
where U^{t} is a total number of messages of the social network member, RT^{u} is a number of the unoriginal messages transmitted by the social network member, and rt^{orig} is a number of original messages that were first transmitted by the social network member prior to any other of the social network members.

5. The method of claim 1, wherein the step of classifying the social network members includes classifying a social network member as a curator if
$$\frac{\sum {RT}^{u}}{\sum {U}^{uniqRT}} > 2$$
where RT^{u} is a number of the unoriginal messages transmitted by the social network member, and U^{uniqRT} is a number of unique social network members from which the social network member has transmitted the unoriginal messages from.

6. The method of claim 1, wherein the step of determining the message content from the message data includes extracting at least one member from the group consisting of unique identifiers of the social network members, a category of the message content, and a transmission time of any of the plurality of messages.

7. The method of claim 1, wherein the step of classifying the social network members is performed in real time.

8. The method of claim 1, further comprising causing display of the message content in schematic form.

9. A server device adapted to analyze social media content comprising:
a transceiver adapted to receive message data from a social network;
a processor adapted to:
determine message content from the message data;
categorize a plurality of messages as having a same message content;
determine social network members who have transmitted the same message content; and
classify the social network members according to influence on a transmission of the same message content, the influence being determined by analyzing a number of times the social network members transmitted an unoriginal message previously received by the respective social network member.

10. The server device of claim 9, wherein the step of classifying the social network members includes classifying a social network member as an idea starter if
$$\frac{\sum {U}^{rt}}{{RT}^{min}} > 1$$
where U^{rt} is a number of unoriginal shared messages and RT^{min} is a minimum number of unoriginal shared messages.

11. The server device of claim 10, wherein the minimum number of unoriginal shared messages is one of determined by a user and predetermined prior to the step of classifying the social network members.

12. The server device of claim 9, wherein the processor is adapted to classify the social network member as an amplifier if
$$\frac{\sum {U}^{t}}{\sum {RT}^{u} \times \sum {rt}^{orig}} > 1$$
where U^{t} is a total number of messages of the social network member, RT^{u} is a number of the unoriginal messages transmitted by the social network member, and rt^{orig} is a number of original messages that were first transmitted by the social network member prior to any other of the social network members.

13. The server device of claim 9, wherein the processor is adapted to classify the social network member as a curator if
$$\frac{\sum {RT}^{u}}{\sum {U}^{uniqRT}} > 2$$
where RT^{u} is a number of the unoriginal messages transmitted by the social network member, and U^{uniqRT} is a number of unique social network members from which the social network member has transmitted the unoriginal messages from.

14. The server device of claim 9, wherein the step of determining the message content from the message data includes extracting at least one member from the group consisting of unique identifiers of the social network members, a category of the message content, and a transmission time of any of the plurality of messages.

15. The server device of claim 9, wherein the processor classifies the social network members in real time.

16. The server device of claim 9, wherein the processor is further adapted to cause display of the message content in schematic form.

17. A computer readable medium storing instructions executable by a processor and comprising:
instructions to receive message data from a social network;
instructions to determine a message content from the message data;
instructions to categorize a plurality of messages as having a same message content;
instructions to determine social network members who have transmitted the same message content; and
instructions to classify the social network members according to influence on a transmission of the same message content, the influence being determined by analyzing a number of times the social network members transmitted an unoriginal message previously received by the respective social network member.

18. The computer readable medium of claim 17, wherein the step of classifying the social network members includes classifying a social network member as an idea starter if
$$\frac{\sum {U}^{rt}}{{RT}^{min}} > 1$$
where U^{rt} is a number of unoriginal shared messages and RT^{min} is a minimum number of unoriginal shared messages.

19. The computer readable medium of claim 18, wherein the minimum number of unoriginal shared messages is one of determined by a user and predetermined prior to the step of classifying the social network members.

20. The computer readable medium of claim 17, wherein the instructions to classify the social network members includes instructions to classify a social network member as an amplifier if
$$\frac{\sum {U}^{t}}{\sum {RT}^{u} \times \sum {rt}^{orig}} > 1$$
where U^{t} is a total number of messages of the social network member, RT^{u} is a number of the unoriginal messages transmitted by the social network member, and rt^{orig} is a number of original messages that were first transmitted by the social network member prior to any other of the social network members.

21. The computer readable medium of claim 17, wherein the instructions to classify the social network members includes instructions to classify a social network member as a curator if
$$\frac{\sum {RT}^{u}}{\sum {U}^{uniqRT}} > 2$$
where RT^{u} is a number of the unoriginal messages transmitted by the social network member, and U^{uniqRT} is a number of unique social network members from which the social network member has transmitted the unoriginal messages from.

22. The computer readable medium of claim 17, wherein the instructions to determine the message content from the message data includes instructions to extract at least one member from the group consisting of unique identifiers of the social network members, a category of the message content, and a transmission time of any of the plurality of messages.

23. The computer readable medium of claim 17, wherein the instructions to classify the social network members is performed in real time.

24. The computer readable medium of claim 17, further comprising instructions to cause display of the message content in schematic form.
